(19) United States
(12) Patent Application Publication
(10) Pub. No.: US 2023/0162067 A1
(43) Pub. Date: May 25, 2023

(54) COMPUTER-READABLE RECORDING MEDIUM STORING CAUSAL SEARCH PROGRAM, CAUSAL SEARCH METHOD, AND INFORMATION PROCESSING APPARATUS

(71) Applicant: FUJITSU LIMITED, Kawasaki-shi (JP)

(72) Inventor: Kazuhito MATSUDA, Kawasaki (JP)

(73) Assignee: FUJITSU LIMITED, Kawasaki-shi (JP)

(21) Appl. No.: 17/872,039

(22) Filed: Jul. 25, 2022

(30) Foreign Application Priority Data
Nov. 19, 2021 (JP) 2021-188263

(51) Int. Cl. G06N 7/00; G06F 9/54

(52) U.S. Cl. CPC G06N 7/005; G06F 9/54

(57) ABSTRACT

A recording medium stores a program for causing a computer to execute a process including: executing, based on first sample data including a numerical string of each variable, parallel processing of calculation of a first statistical information amount between each variable and another variable; sharing the first statistical information amount between the processes; determining a first variable to be a beginning of a causal order in which the variables is arranged in such a manner that a variable that is a cause in a causal relationship between the variables precedes based on the first statistical information amount; estimating a second variable to be next in the causal order; and determining calculation of a second statistical information amount and calculation of a third statistical information amount based on third sample data obtained by removing the contribution of the first variable and the second variable from the first sample data.

### CROSS-REFERENCE TO RELATED APPLICATION

This application is based upon and claims the benefit of priority of the prior Japanese Patent Application No. 2021-188263, filed on Nov. 19, 2021, the entire contents of which are incorporated herein by reference.

### FIELD

The embodiments discussed herein are related to a causal search program, a causal search method, and an information processing apparatus.

### BACKGROUND

A direct linear non-gaussian acyclic model (DirectLiNGAM) is one of methods for searching for a causal relationship between variables on the basis of an observed random variable sample. With DirectLiNGAM used, it becomes possible to obtain a cause-effect relationship between variables, not a correlative relationship.

Japanese Laid-open Patent Publication No. 2014-49921 is disclosed as related art.

### SUMMARY

According to an aspect of the embodiments, a non-transitory computer-readable recording medium stores a causal search program for causing a computer to execute a process including: executing, on the basis of first sample data that includes a numerical string of each of a plurality of variables to be calculated, parallel processing of calculation of a first statistical information amount between each of the plurality of variables and another variable through a plurality of processes; sharing the first statistical information amount of each of the plurality of variables between the plurality of processes; determining a first variable to be a beginning of a causal order in which the plurality of variables is arranged in such a manner that a variable that may be a cause in a causal relationship between the plurality of variables precedes on the basis of the first statistical information amount of each of the plurality of variables through each of the plurality of processes; estimating a second variable to be next to the first variable in the causal order among the plurality of variables on the basis of the first statistical information amount of each of the plurality of variables through each of the plurality of processes; and determining, through each of the plurality of processes, calculation execution of a second statistical information amount between each of remaining variables in which the first variable is excluded from the plurality of variables and other remaining variables based on second sample data obtained by removing a contribution of the first variable from the first sample data and calculation execution of a third statistical information amount between each of remaining variables in which the first variable and the second variable are excluded from the plurality of variables and the other remaining variables based on third sample data obtained by removing the contribution of the first variable and the second variable from the first sample data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary causal search method according to a first embodiment;

FIG. 2 is a diagram illustrating an exemplary system configuration according to a second embodiment;

FIG. 3 is a diagram illustrating exemplary hardware of a control node;

FIG. 4 is a diagram illustrating an exemplary hardware configuration of a computation node;

FIG. 5 is a diagram illustrating an exemplary causal relationship search;

FIG. 6 is a diagram illustrating a relationship between a degree of search progress of a causal relationship and a degree of parallelism;

FIG. 7 is a diagram illustrating exemplary processing progress in a case where there is negotiation for speculative execution;

FIG. 8 is a diagram illustrating an exemplary method of determining speculative execution content based only on information that may be known by normal processing of DirectLiNGAM;

FIG. 9 is a block diagram illustrating functions of individual devices for implementing the speculative execution of the causal relationship search;

FIG. 10 is a diagram illustrating exemplary sample data;

FIG. 11 is a diagram illustrating an exemplary job execution instruction;

FIG. 12 is a diagram illustrating an exemplary procedure of a causal order determination process;

FIG. 13 is the first half of a flowchart illustrating an exemplary procedure of a process of searching for a variable at the beginning of the causal order;

FIG. 14 is the latter half of the flowchart illustrating the exemplary procedure of the process of searching for the variable at the beginning of the causal order;

FIG. 15 is a first diagram illustrating exemplary causal order determination; and

FIG. 16 is a second diagram illustrating exemplary causal order determination.

### DESCRIPTION OF EMBODIMENTS

The causal relationship search by DirectLiNGAM may be carried out at high speed by parallel processing. For example, it becomes possible to execute a large number of processes in parallel by using a supercomputer. In view of the above, in the parallel processing, it is important how to divide a dependence relationship between calculation results and increase the parts that may be executed in parallel. According to DirectLiNGAM, many processes are independent calculations for each variable, which makes it possible to execute those calculations in parallel. Note that, in the parallel processing of DirectLiNGAM, a plurality of processes that has executed the calculation for each variable shares the calculation result, and a process of determining the next processing (synchronous processing) using the shared calculation result is executed at a predetermined timing.

For the causal relationship search process, for example, there has been proposed a quality deterioration factor estimation device that estimates an effect and its cause between observed variables and identifies a factor when quality deterioration occurs without using the existing time order of causal relationships.

According to DirectLiNGAM, a process of determining the causal order is performed. In the process of determining the causal order, first, the beginning of the causal order is determined from all variables. Then, the influence of the variable determined as the beginning is removed, and the beginning of the causal order among the remaining variables is determined. The variable determined as the beginning is in the order following the variable determined immediately before in the causal order. With such a process of determining the beginning of the causal order repeated, the causal order of all the variables is determined.

Here, the parallel processing for each variable is possible even in the causal order search. However, in the causal order search process, the number of variables to be calculated decreases each time the process is repeated, and the degree of parallelism decreases. In this case, with speculative execution of the process carried out, it becomes possible to effectively utilize surplus resources due to the decrease in the degree of parallelism. The speculative execution indicates that a process that may be performed later is performed before it is confirmed to be performed.

In the speculative execution of the process, when each of the processes that execute the parallel processing perform new synchronous processing to determine processing content to be executed next, extra communication time for the synchronous processing is generated. As a result, the total calculation time until the causal order of all variables is determined increases, and the effect of the speculative execution is diminished. Note that, not limited to DirectLiNGAM, a similar problem occurs in a method of determining the causal order from the beginning.

In one aspect, the present case aims to efficiently carry out a causal order search between variables.

Hereinafter, the present embodiments will be described with reference to the drawings. Note that each of the embodiments may be implemented in combination with a plurality of embodiments as long as no contradiction arises.

### First Embodiment

A first embodiment is directed to a causal search method capable of searching for a causal order by efficient speculative execution.

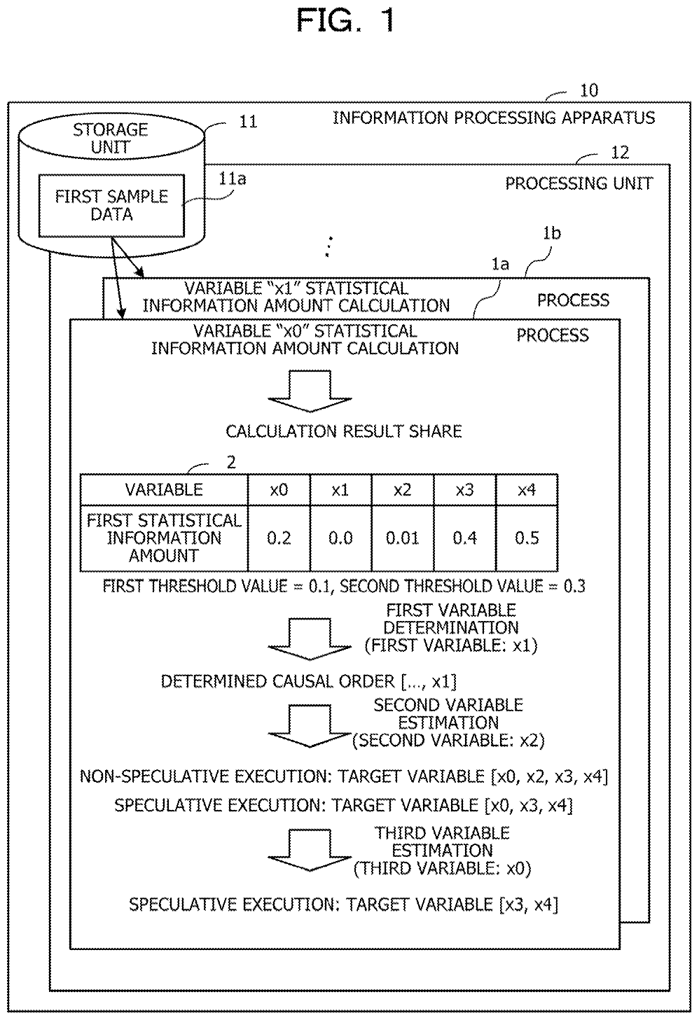

FIG. 1 is a diagram illustrating an exemplary causal search method according to the first embodiment. FIG. 1 illustrates an information processing apparatus 10 that implements the causal search method. The information processing apparatus 10 is capable of implementing the causal search method by, for example, executing a causal search program.

The information processing apparatus 10 includes a storage unit 11 and a processing unit 12. The storage unit 11 is, for example, a memory or a storage device included in the information processing apparatus 10. The processing unit 12 is, for example, a processor or an arithmetic circuit included in the information processing apparatus 10.

The storage unit 11 stores first sample data 11a including a numerical string of each of a plurality of variables to be calculated.

The processing unit 12 executes parallel processing of calculations of a first statistical information amount between each of the plurality of variables and another variable on the basis of the first sample data 11a through a plurality of processes 1a, 1b, and so on. The first statistical information amount is, for example, the sum of squares of mutual information amounts between the variable to be calculated and each of other variables (sum of the squares of the individual mutual information amounts). In the example of FIG. 1, the process 1a calculates the first statistical information amount of a variable “x0”, and the process 1b calculates the first statistical information amount of a variable “x1”.

Next, the processing unit 12 shares the first statistical information amount for each of the plurality of variables among the plurality of processes ha, 1b, and so on. For example, the plurality of processes ha, 1b, and so on communicate with each other, and transmit the first statistical information amounts calculated by themselves to all other processes. As a result, each of the plurality of processes ha, 1b, and so on is enabled to obtain inter-process shared information 2 including the first statistical information amount of each of the plurality of plurality of variables. For example, the inter-process shared information 2 illustrated in FIG. 1 includes the first statistical information amount of each of five variables calculated by different processes.

Next, the processing unit 12 determines, through each of the plurality of processes ha, 1b, and so on, a first variable to be the beginning of the causal order in which the plurality of variables is arranged in such a manner that a variable that may be the cause in the causal relationship between the plurality of variables precedes on the basis of the first statistical information amount of each of the plurality of variables. For example, the plurality of processes ha, 1b, and so on determines the variable with the smallest value of the first statistical information amount as the first variable. In the example of FIG. 1, the variable “x1” with the value of the first statistical information amount “0” is determined as the first variable.

Next, the processing unit 12 estimates a second variable next to the first variable in the causal order among the plurality of variables on the basis of the first statistical information amount of each of the plurality of variables through each of the plurality of processes 1a, 1b, and so on. For example, the plurality of processes 1a, 1b, and so on estimate, as the second variable, a variable other than the first variable and having a value of the first statistical information amount equal to or smaller than a first threshold value. In the example of FIG. 1, the first threshold value is “0.1”. Only the variable “x2” has the first statistical information amount equal to or smaller than the first threshold value except for the variable “x1”, which is the first variable. Accordingly, the variable “x2” is estimated as the second variable.

Next, the processing unit 12 determines execution of calculation of a second statistical information amount and execution of calculation of a third statistical information amount through each of the plurality of processes 1a, 1b, and so on. The second statistical information amount is a statistical information amount between each of remaining variables in which the first variable is excluded from the plurality of variables and the other remaining variables based on second sample data obtained by removing the contribution of the first variable from the first sample data 11a. The third statistical information amount is a statistical information amount between each of remaining variables in which the first variable and the second variable are excluded from the plurality of variables and the other remaining variables based on third sample data obtained by removing the contribution of the first variable and the second variable from the first sample data. The second statistical information amount and the third statistical information amount are, for example, the sum of squares of the mutual information amount.

The calculation of the second statistical information amount is calculation for obtaining a variable to be the next causal order on the basis of the determined causal order, and execution of this calculation is non-speculative execution. In the example of FIG. 1, target variables to be calculated in the calculation of the second statistical information amount (non-speculative execution) are variables “x0, x2, x3, and x4” whose causal order is undetermined. Meanwhile, the calculation of the third statistical information amount is calculation for obtaining a variable to be the next causal order on the basis of the estimated causal order, and execution of this calculation is speculative execution. In the example of FIG. 1, target variables to be calculated in the calculation of the third statistical information amount (speculative execution) are variables “x0, x3, and x4” whose causal order is undetermined and whose causal order is not estimated.

Then, the processing unit 12 determines which variable to calculate the second statistical information amount or the third statistical information amount through each of the plurality of processes 1a, 1b, and so on on the basis of its own process ID, and calculates the second statistical information amount or the third statistical information amount of the determined variable.

In this manner, each of the plurality of processes 1a, 1b, and so on is enabled to perform the speculative execution of the search for the causal order ahead of the determined causal order without performing excess inter-process communication for the speculative execution. As a result, the efficiency in the causal order search improves.

Furthermore, since the second variable is estimated on the basis of the first statistical information amount of each of the calculated variables, it becomes possible to improve the possibility that the causal order is determined as estimated. Accordingly, the speculative execution result may be effectively utilized, and the time for the causal order search may be shortened.

Note that there may be a plurality of the second variables in determining the execution of the calculation of the third statistical information amount in the plurality of processes 1a, 1b, and so on. In this case, the processing unit 12 causes each of the plurality of processes 1a, 1b, and so on to determine the execution of the calculation of the third statistical information amount for each of the plurality of second variables within a range allowed by available computational resources. For example, the plurality of processes 1a, 1b, and so on determine the execution of the calculation of the third statistical information amount in order from the variable with the smallest value of the first statistical information amount among the plurality of second variables. Estimating the plurality of second variables as the next variables in such a determined causal order and performing the speculative execution of the calculation of the statistical information amount for each of them may be called horizontal speculative execution.

Furthermore, the processing unit 12 estimates a third variable next to the second variable in the causal order among the plurality of variables on the basis of the first statistical information amount of each of the plurality of variables through each of the plurality of processes 1a, 1b, and so on. For example, a variable other than the first variable and having the first statistical information amount equal to or smaller than a second threshold value is estimated as the third variable. The second threshold value is a value larger than the first threshold value, and in the example of FIG. 1, the second threshold value is “0.3”. Only the variable “x0” is a variable that exceeds the first threshold value and is equal to or less than the second threshold value. Accordingly, the variable “x0” is estimated as the third variable.

Moreover, the processing unit 12 determines execution of calculation of a fourth statistical information amount based on fourth sample data obtained by removing the contribution of the first variable, the second variable, and the third variable from the first sample data through each of the plurality of processes 1a, 1b, and so on. The fourth statistical information amount is a statistical information amount between each of the plurality of variables other than the first variable, the second variable, and the third variable and other variables (e.g., sum of squares of mutual information amount). The calculation of the fourth statistical information amount is calculation for obtaining a variable to be the next causal order on the basis of the estimated causal order, and execution of this calculation is speculative execution. In the example of FIG. 1, target variables to be calculated in the calculation of the fourth statistical information amount (speculative execution) are variables “x3 and x4” whose causal order is undetermined and whose causal order is not estimated.

Since the execution of the calculation of the fourth statistical information amount estimates the further next variable of the variable whose causal order is estimated, it may be called vertical speculative execution. With the vertical speculative execution performed, it becomes possible to effectively utilize the vertical speculative execution result to shorten the processing time when the estimation is correct. Furthermore, a variable that exceeds the first threshold value and is equal to or less than the second threshold value is estimated as the third variable, whereby it becomes possible to improve the accuracy in estimation.

### Second Embodiment

Next, a second embodiment will be described. The second embodiment efficiently carries out a causal relationship search using a large-scale parallel computer system such as a supercomputer.

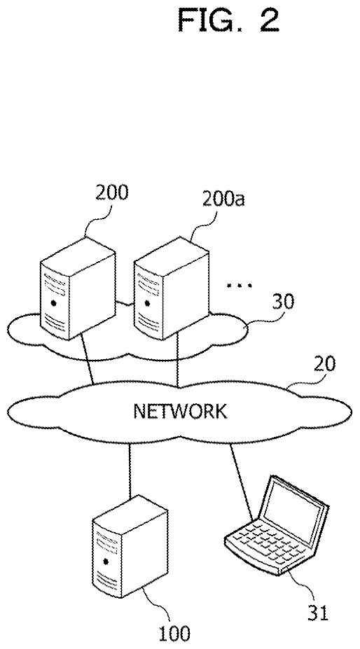

FIG. 2 is a diagram illustrating an exemplary system configuration according to the second embodiment. A plurality of computation nodes 200, 200a, and so on are mutually connected by an interconnect 30 capable of performing high-speed communication. The interconnect 30 is, for example, a network in which processors are interconnected by a six-dimensional mesh/torus.

Each of the computation nodes 200, 200a, and so on is also connected to a network 20 for control. A control node 100 and a terminal 31 are further connected to the network 20. The control node 100 issues a job execution instruction to the computation nodes 200, 200a, and so on. The terminal 31 registers, in the control node 100, information regarding a job to be executed by the computation nodes 200, 200a, and so on on the basis of a user operation.

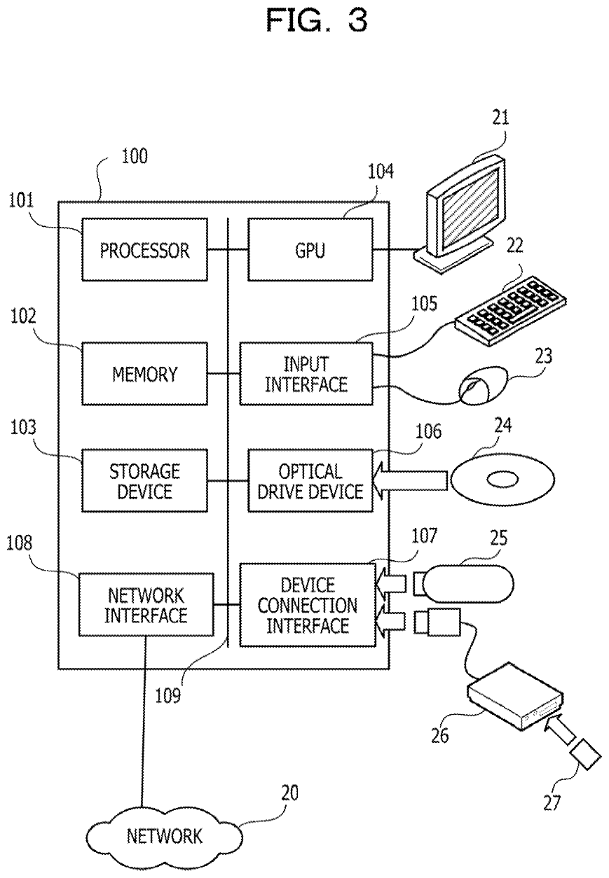

FIG. 3 is a diagram illustrating exemplary hardware of the control node. The control node 100 is subject to overall control performed by a processor 101. A memory 102 and a plurality of peripheral devices are connected to the processor 101 via a bus 109. The processor 101 may be a multiprocessor. The processor 101 is, for example, a central processing unit (CPU), a micro processing unit (MPU), or a digital signal processor (DSP). At least a part of functions implemented by the processor 101 executing a program may be implemented by an electronic circuit such as an application specific integrated circuit (ASIC) or a programmable logic device (PLD).

The memory 102 is used as a main storage device of the control node 100. The memory 102 temporarily stores at least a part of an operating system (OS) program and an application program to be executed by the processor 101. Furthermore, the memory 102 stores various types of data to be used in processing by the processor 101. As the memory 102, for example, a volatile semiconductor storage device such as a random access memory (RAM) is used.

Examples of the peripheral devices connected to the bus 109 include a storage device 103, a graphics processing unit (GPU) 104, an input interface 105, an optical drive device 106, a device connection interface 107, and a network interface 108.

The storage device 103 electrically or magnetically performs data writing and reading on a built-in recording medium. The storage device 103 is used as an auxiliary storage device of the control node 100. The storage device 103 stores an OS program, an application program, and various types of data. Note that, as the storage device 103, for example, a hard disk drive (HDD) or a solid state drive (SSD) may be used.

The GPU 104 is an arithmetic unit that performs image processing, and is also called a graphic controller. A monitor 21 is connected to the GPU 104. The GPU 104 causes an image to be displayed on a screen of the monitor 21 in accordance with an instruction from the processor 101. Examples of the monitor 21 include a display device using organic electro luminescence (EL), a liquid crystal display device, and the like.

A keyboard 22 and a mouse 23 are connected to the input interface 105. The input interface 105 transmits signals transmitted from the keyboard 22 and the mouse 23 to the processor 101. Note that the mouse 23 is an example of a pointing device, and another pointing device may also be used. Examples of the another pointing device include a touch panel, a tablet, a touch pad, a track ball, and the like.

The optical drive device 106 uses laser light or the like to read data recorded in an optical disk 24 or write data to the optical disk 24. The optical disk 24 is a portable recording medium in which data is recorded to be readable by reflection of light. Examples of the optical disk 24 include a digital versatile disc (DVD), a DVD-RAM, a compact disc read only memory (CD-ROM), a CD-recordable (R)/rewritable (RW), and the like.

The device connection interface 107 is a communication interface for connecting peripheral devices to the control node 100. For example, a memory device 25 and a memory reader/writer 26 may be connected to the device connection interface 107. The memory device 25 is a recording medium equipped with a communication function with the device connection interface 107. The memory reader/writer 26 is a device that writes data in a memory card 27 or reads data from the memory card 27. The memory card 27 is a card-type recording medium.

The network interface 108 is connected to the network 20. The network interface 108 transmits/receives data to/from another computer or a communication device via the network 20. The network interface 108 is a wired communication interface connected to a wired communication device such as a switch or a router with a cable, for example. Furthermore, the network interface 108 may be a wireless communication interface that is connected to and communicates with a wireless communication device such as a base station or an access point with radio waves.

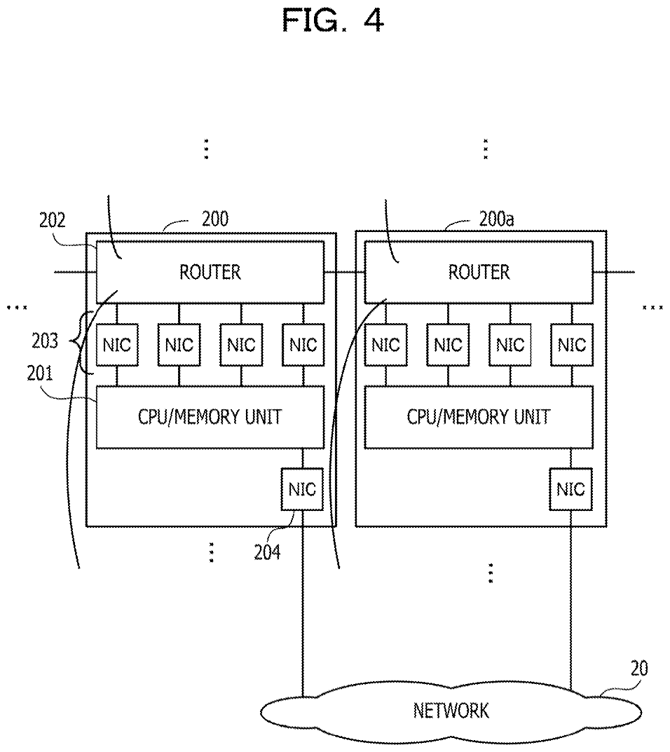

FIG. 4 is a diagram illustrating an exemplary hardware configuration of the computation node. The computation node 200 includes a CPU/memory unit 201 and a router 202. The CPU/memory unit 201 and the router 202 are connected by a plurality of communication interfaces (network interface cards (NICs)) 203. Furthermore, a NIC 204 for connecting to the network 20 for control is also connected to the CPU/memory unit 201.

The CPU/memory unit 201 includes a CPU having multiple cores and a memory. In the CPU/memory unit 201, a process (processing execution unit) is generated for each core. In a case where the process for each core of the CPU/memory unit 201 performs synchronous processing with a process in another computation node, it communicates with the another computation node 200a or the like via the router 202.

The router 202 communicates with, for example, a computation node adjacent in each of the three-dimensional direction. The router 202 transmits data to be transmitted from the CPU/memory unit 201 to another computation node to the adjacent computation node in the direction corresponding to the position of the computation node in the interconnect 30. Furthermore, when the router 202 receives data from the adjacent computation node to the process in the CPU/memory unit 201, it transmits the data to the CPU/memory unit 201. Moreover, in a case where the data received from the adjacent computation node is data directed to another computation node, the router 202 transmits the data to the adjacent computation node in the direction corresponding to the position of the computation node of the transmission destination in the interconnect 30.

Another computation node 200a or the like has a hardware configuration similar to that of the computation node 200. With the computation nodes 200, 200a, and so on of the hardware as illustrated in FIG. 4 subject to the mesh/torus connection in the three-dimensional direction, a three-dimensional mesh/torus network is achieved. A plurality of three-dimensional computation node groups subject to the mesh/torus connection is generated, and the plurality of computation node groups is further subject to the mesh/torus connection in the three-dimensional direction, whereby a six-dimensional mesh/torus network is achieved.

The control node 100 and the computation nodes 200, 200a, and so on of the hardware as described above may implement the processing functions according to the second embodiment. Note that the information processing apparatus 10 indicated in the first embodiment may also be implemented by hardware similar to that of the computation node 200 illustrated in FIG. 4.

The control node 100 and the computation nodes 200, 200a, and so on implement the processing functions according to the second embodiment by, for example, executing a program recorded in a computer-readable recording medium. The program in which processing content to be executed by the control node 100 or the computation node 200, 200a, or the like may be recorded in various recording media. For example, the program to be executed by the control node 100 or the computation node 200, 200a, or the like may be stored in the storage device 103. The processor 101 or the core in the CPU/memory unit 201 loads at least a part of the program in the storage device 103 to execute the program. Furthermore, the program to be executed by the control node 100 or the computation node 200, 200a, or the like may be recorded in a portable recording medium such as the optical disk 24, the memory device 25, or the memory card 27.

The large number of computation nodes 200, 200a, and so on as illustrated in FIG. 4 may carry out a causal relationship search based on DirectLiNGAM.

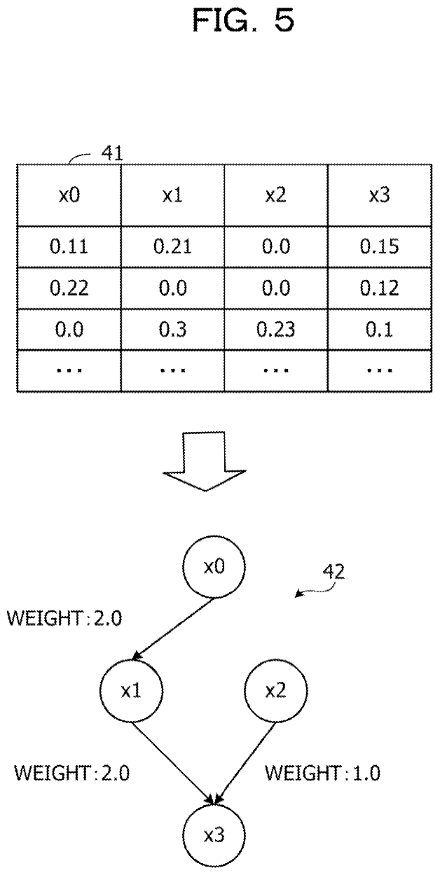

FIG. 5 is a diagram illustrating an exemplary causal relationship search. In the causal relationship search, a causal graph 42 is generated on the basis of sample data 41. In the sample data 41, an array of observed numerical values for each of the plurality of variables (random variables) is registered.

While a correlative relationship between variables is commonly obtained by carrying out correlation analysis of values of two variables, it is not easy to derive a causal relationship. One of methods for deriving a causal relationship is DirectLiNGAM. According to DirectLiNGAM, it becomes possible to derive the presence or absence of a causal relationship between two variables. In the causal graph 42, each variable is represented by a node, and the nodes corresponding to the variables having a causal relationship are connected by an arrow (directed path). The source of the arrow indicates the variable indicating the cause of the causal relationship, and the destination of the arrow indicates the variable indicating the result of the causal relationship. The strength of the causal relationship is expressed as a weight.

The computation nodes 200, 200a, and so on that search for the causal relationship according to DirectLiNGAM calculate the causal order by the following procedure. The causal order is obtained by arranging variables in such a manner that a variable that may be the cause in the causal relationship precedes and a variable that may be the result follows.

Step 1: The computation nodes 200, 200a, and so on perform bidirectional regression analysis on all combinations of variables, and calculate a difference in entropy of their residuals. This difference in entropy of the residuals is called a mutual information amount.

Step 2: The computation nodes 200, 200a, and so on calculate the sum of squares of the mutual information amount calculated for each variable.

Step 3: The computation nodes 200, 200a, and so on determine the variable with the smallest calculated sum of squares as the beginning of the causal relationship.

Step 4: The computation nodes 200, 200a, and so on perform regression analysis of other variables with the variable determined as the beginning of the causal relationship, and use the residuals as new sample data. This is a process of removing the contribution of the variable determined as the beginning of the causality from the sample data.

Step 5: The computation nodes 200, 200a, and so on remove the value of the variable estimated as the beginning of the causal relationship from the sample data.

The computation nodes 200, 200a, and so on repeat steps 1 to 5 until the causal order of all the variables is determined. When the causal order of all the variables is determined, the computation nodes 200, 200a, and so on calculate, for each variable, a weight of the causal relationship from the variable whose causal order is earlier than the variable by a predetermined calculation method. The computation nodes 200, 200a, and so on determine that there is a causal relationship when the value of the weight is equal to or greater than a predetermined value. Then, the computation nodes 200, 200a, and so on generate the causal graph 42 in which the nodes corresponding to the variables determined to have a causal relationship are connected by an arrow. In this case, the preceding variable in the causal order indicates the source (cause) of the arrow, and the succeeding variable in the causal order indicates the destination (result) of the arrow.

In this manner, the causal order of the variables is first obtained to obtain the causal relationship according to DirectLiNGAM. Of the plurality of steps of the process for obtaining the causal order, the processing of step 1 may be independently calculated for each variable. For example, the processing of step 1 may be performed in parallel.

For example, in a case where the target variables (variables whose causal order is undetermined) to be subject to the causal order determination are “x0, x1, x2, x3, and x4”, each process (assumed to have process ID p1, p2, or the like) is caused to execute the following calculation. —The sum of squares of mutual information amount with each of “x1, x2, x3, and x4” is calculated on the basis of p1: x0. —The sum of squares of mutual information amount with each of “x0, x2, x3, and x4” is calculated on the basis of p2: x1. —The sum of squares of mutual information amount with each of “x0, x1, x3, and x4” is calculated on the basis of p3: x2. —The sum of squares of mutual information amount with each of “x0, x1, x2, and x4” is calculated on the basis of p4: x3. —The sum of squares of mutual information amount with each of “x0, x1, x2, and x3” is calculated on the basis of p5: x4.

In this manner, a reference variable is assigned to each process, and each process calculates the sum of squares of mutual information amount associated with the assigned variable in parallel. Then, each process shares the calculated sum of squares of mutual information amount by inter-process communication, and sets the variable with the minimum value as the beginning of the causal order among the target variables.

When the number of the target variables is “5” as described above, the degree of parallelism in the calculation of the sum of squares of the mutual information amount is also “5”. When the variable at the beginning of the causal order among the target variables is determined, the sum of squares of the mutual information amount is calculated using the remaining variables obtained by removing that variable as the target variables. For example, the number of the target variables is reduced by one. Accordingly, each time the variable at the beginning of the causal order among the target variables is determined, the degree of parallelism in the next calculation of the sum of squares of the mutual information amount decreases. For example, in a case where the beginning of the causal order when the target variables are “x0, x1, x2, x3, and x4” is determined to be “x0”, the target variables are updated to four variables “x1, x2, x3, and x4”. As a result, the degree of parallelism decreases from “5” to “4”.

Due to such properties, in the calculation of the sum of squares of the mutual information amount, the degree of parallelism peaks out at the number of the target variables, and the degree of parallelism decreases as the search progresses. When the degree of parallelism decreases, the efficiency in utilizing computational resources decreases. In view of the above, the computation nodes 200, 200a, and so on perform speculative execution of the causal relationship search to effectively utilizing surplus computational resources.

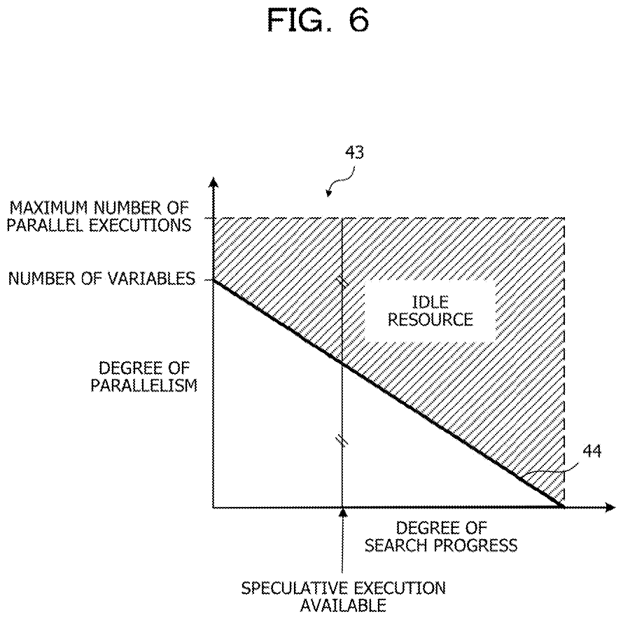

FIG. 6 is a diagram illustrating a relationship between a degree of search progress of the causal relationship and the degree of parallelism. A graph 43 illustrated in FIG. 6 has a horizontal axis representing a degree of search progress, and a vertical axis representing a degree of parallelism of calculation of the sum of squares of the mutual information amount. In the degree of search progress, a degree of progress advances by “1” each time one beginning of the causal order among the target variables is determined.

The degree of parallelism according to the degree of search progress is represented by a straight line 44. The degree of parallelism in the situation at the start of the search (degree of search progress is “0”) is equal to the number of variables indicated in the sample data 41. The degree of parallelism decreases as the search progresses.

Here, the number of cores that may be used for the causal relationship search indicates the maximum number of parallel executions. In the graph 43, the area above the straight line 44 up to the maximum number of parallel executions represents the amount of idle resources (number of cores). When the degree of parallelism becomes equal to or less than half of the maximum number of parallel executions, the speculative execution using the idle resources becomes available.

In the speculative execution of the causal relationship search according to DirectLiNGAM, the computation nodes 200, 200a, and so on estimate the variable at the beginning of the undetermined causal order, and perform calculation for determining the causal order ahead of that. In a case where the variable at the beginning of the causal order determined by non-speculative processing matches the estimated variable (hereinafter referred to as a hit), the computation nodes 200, 200a, and so on determine the variable obtained by the causal order calculation ahead of the estimated variable as the variable of the next causal order in the causal order. This shortens the total calculation time.

Meanwhile, the number of available speculative executions is limited by the amount of the computational resources and the number of target variables. For example, in order to advance the speculative execution by one step, computational resources (number of cores) that may execute the degree of parallelism one less than the degree of parallelism of the main process group that is not the speculative execution are used. Accordingly, available speculative execution patterns are at most a few patterns in many cases. On the other hand, there are as many speculative execution patterns that may be taken as the number of variables (target variables) whose causal order is undetermined. Accordingly, in a case where the number of target variables is 10³ or the like, the possibility of a speculative execution hit is almost zero when the variable of the next causal order is randomly estimated. In view of the above, it is important to estimate the variable at the beginning of the undetermined causal order by an estimation method that maximizes a hit rate.

Furthermore, when negotiation is performed over the interconnect 30 to determine the speculative execution content, the processing time for that is to be an overhead. In view of the above, the speculative execution content needs to be determined using only the information that may be known by individual processes and without duplication.

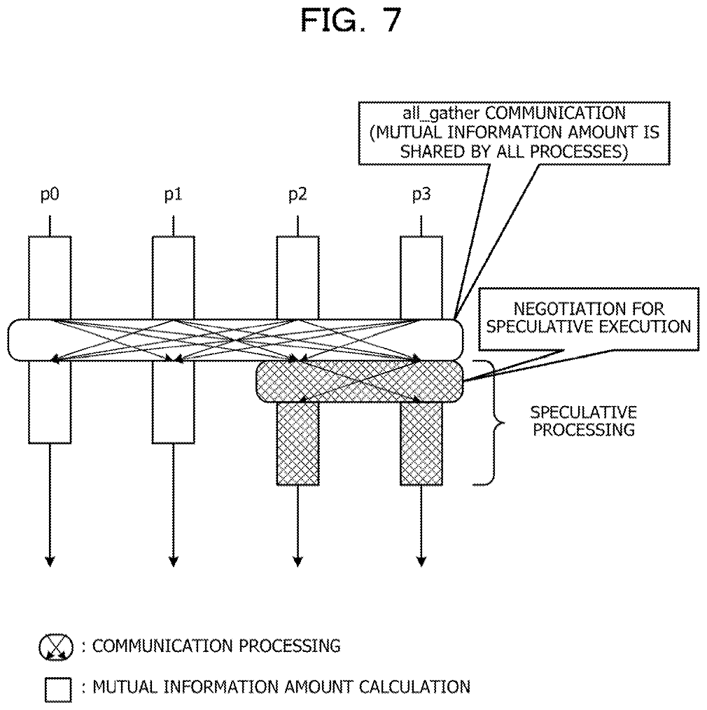

FIG. 7 is a diagram illustrating exemplary processing progress in a case where there is negotiation for speculative execution. In the example of FIG. 7, four processes are executing processing in parallel. When each of the processes terminates the calculation of the sum of squares of the mutual information amount, gather (all_gather) communication for all the processes is performed. Thereafter, communication for negotiation is performed between the processes that execute the speculative execution.

When such additional communication is performed for the speculative execution in this manner, a delay occurs in the non-speculative processing, thereby increasing the total calculation time. In view of the above, according to the second embodiment, each process of the computation nodes 200, 200a, and so on determines the speculative execution content only on the basis of the information that may be known by normal processing of DirectLiNGAM, whereby the negotiation for determining the speculative execution content is not needed.

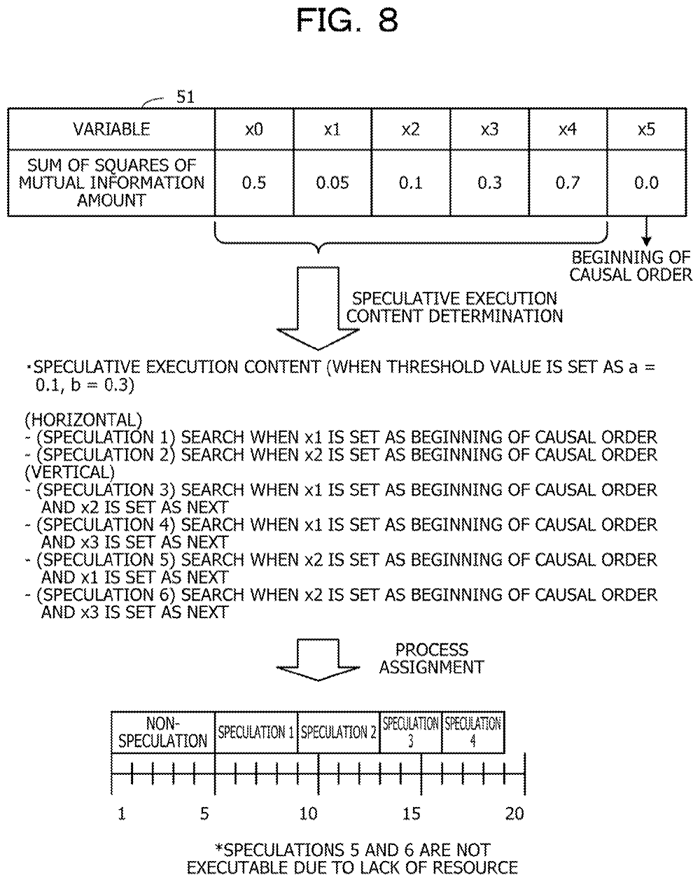

FIG. 8 is a diagram illustrating an exemplary method of determining the speculative execution content based only on the information that may be known by the normal processing of DirectLiNGAM. The sum of squares of the mutual information amount obtained in the process of DirectLiNGAM indicates that the smaller the value, the less likely it is that the variable has another variable as the parent of the causality. In view of the above, when the sum of squares of the mutual information amount is equal to or less than a certain first threshold value a, each process executed in the computation nodes 200, 200a, and so on estimates (tentatively determines) the variable as the beginning of the next causality. The first threshold value a is empirically determined by the user, for example. Note that, in a case where there is a plurality of variables in which the sum of squares of the mutual information amount is equal to or less than the first threshold value a, each process determines that the speculative execution is to be carried out for as many variables as the surplus computational resources allow. Such speculative execution is called horizontal speculative execution.

In a case where there are further surplus computational resources after determining the horizontal speculative execution content, when the variable with the next smallest mutual information amount following the variable estimated as the beginning of the causality by the horizontal speculative execution is equal to or less than a second threshold value b, each process estimates the variable as the beginning of the next causal order. Such speculative execution is called vertical speculative execution.

Then, each process determines the content of the processing (non-speculative execution or speculative execution) to be executed on the basis of its own process ID, and executes the processing.

Inter-process shared information 51 illustrated in FIG. 8 is information to be shared by six processes after the sum of squares of the mutual information amount of each of the six target variables “x0, x1, x2, x3, x4, and x5” is executed by those processes. Here, it is assumed that the first threshold value a is “0.1” and the second threshold value b is “0.3”.

The variable “x5” has the smallest sum of squares of the mutual information amount among the target variables. Therefore, each process that has obtained the inter-process shared information 51 determines the variable “x5” as the beginning of the causal order among the target variables. Each process determines the speculative execution content on the basis of the sum of squares of the mutual information amount of the remaining five target variables “x0, x1, x2, x3, and x4” and the two threshold values.

In the example of FIG. 8, the two variables “x1 and x2” have the sum of squares of the mutual information amount equal to or less than the first threshold value a. Accordingly, each process determines the search process when “x1” among the five target variables “x0, x1, x2, x3, and x4” is estimated as the beginning of the causal order as the speculative execution content (speculation 1). Furthermore, each process determines the search process when “x2” among the five target variables “x0, x1, x2, x3, and x4” is estimated as the beginning of the causal order as the speculative execution content (speculation 2).

In a case where there are still surplus computational resources after the determined horizontal speculation is executed, each process determines the vertical speculation content on the basis of the second threshold value b. In the example of FIG. 8, the variables “x1, x2, and x3” among the five target variables “x0, x1, x2, x3, and x4” have the sum of squares of the mutual information amount equal to or less than the second threshold value b.

In view of the above, each process determines the search process when the causal order is estimated that “x2” is next to “x1” estimated as the beginning of the causal order in the “speculation 1” as the speculative execution content (speculation 3). Furthermore, each process determines the search process when the causal order is estimated that “x3” is next to “x1” estimated as the beginning of the causal order in the “speculation 1” as the speculative execution content (speculation 4).

Moreover, each process determines the search process when the causal order is estimated that “x1” is next to “x2” estimated as the beginning of the causal order in the “speculation 2” as the speculative execution content (speculation 5). Furthermore, each process determines the search process when the causal order is estimated that “x3” is next to “x2” estimated as the beginning of the causal order in the “speculation 2” as the speculative execution content (speculation 6).

In this manner, six patterns of speculative execution candidates are determined. Of these, the “speculation 1” and the “speculation 2” are horizontal speculations. The “speculation 3” to “speculation 6” are vertical speculations.

Here, it is assumed that the maximum number of parallel executions (number of processes) is “20”. For example, each process assigns a process for executing each processing in order from the process with the smallest process ID to “non-speculation”, “speculation 1”, “speculation 2”, and so on. Process assignments are made first to non-speculation, then to horizontal speculation, and then to vertical speculation. When there is a plurality of horizontal speculations, for example, the process is preferentially assigned to the one with the smaller sum of squares of the mutual information amount of the estimated variable. Similarly, when there is a plurality of vertical speculations, for example, the process is preferentially assigned to the one with the smaller sum of squares of the mutual information amount of the estimated variable.

Processes with process IDs “1” to “5” are assigned to the “non-speculation” processing. Processes with process IDs “6” to “9” are assigned to the “speculation 1” processing. Processes with process IDs “10” to “13” are assigned to the “speculation 2” processing. Processes with process IDs “14” to “16” are assigned to the “speculation 3” processing. Processes with process IDs “17” to “19” are assigned to the “speculation 4” processing. Surplus computational resources are insufficient to execute the processing of the “speculation 5” and “speculation 6”, and no process is assigned to the processing of the “speculation 5” and “speculation 6”.

Each process identifies the process to which the process is assigned on the basis of its own process ID. Then, each process executes the speculation or non-speculation processing to which the process is assigned. In this manner, each process is enabled to autonomously determine the processing to be executed by itself without performing negotiation with another process on the basis of the inter-process shared information 51 shared in the normal processing of DirectLiNGAM and the two threshold values.

Next, functions of individual devices implemented for the speculative execution of the causal relationship search as illustrated in FIG. 8 will be described.

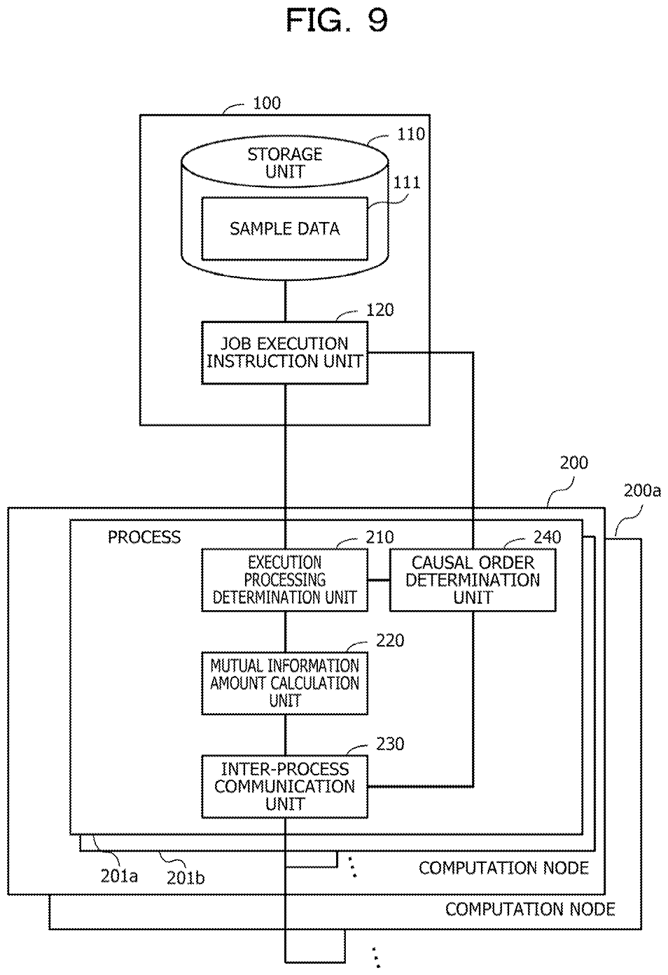

FIG. 9 is a block diagram illustrating the functions of individual devices for implementing the speculative execution of the causal relationship search. The control node 100 includes a storage unit 110 and a job execution instruction unit 120. The storage unit 110 stores sample data 111. The job execution instruction unit 120 instructs the computation nodes 200, 200a, and so on to execute the job for determining the causal order of the plurality of variables. The job execution instruction unit 120 transmits the sample data 111 to the computation nodes 200, 200a, and so on caused to execute the job at the time of instructing the job execution.

The CPU/memory unit 201 (see FIG. 4) of the computation node 200 includes a multi-core CPU. Each of the plurality of cores in the CPU has processes 201a, 201b, and so on for executing a job for determining a causal order of a plurality of variables.

For example, the process 201a includes an execution processing determination unit 210, a mutual information amount calculation unit 220, an inter-process communication unit 230, and a causal order determination unit 240. The execution processing determination unit 210 determines the content of the processing to be executed by the process 201a itself according to the job execution instruction from the control node 100. The mutual information amount calculation unit 220 calculates the sum of squares of the mutual information amount of the variables by non-speculative execution or speculative execution. The inter-process communication unit 230 performs inter-process communication with all other processes that execute the same job in parallel, and shares the calculation result of the sum of squares of the mutual information amount of the variables. The causal order determination unit 240 determines the causal order on the basis of the inter-process shared information shared by the inter-process communication.

Other processes 201b and so on have functions similar to those of the process 201a. Furthermore, multiple processes having the functions similar to those of the process 201a are executed also in the computation node 200a and so on other than the computation node 200.

Note that, lines connecting the individual elements illustrated in FIG. 9 indicate a part of a communication path, and a communication path other than the illustrated communication path may also be set. Furthermore, the function of each element illustrated in FIG. 9 may be implemented by, for example, causing a computer to execute a program module corresponding to the element.

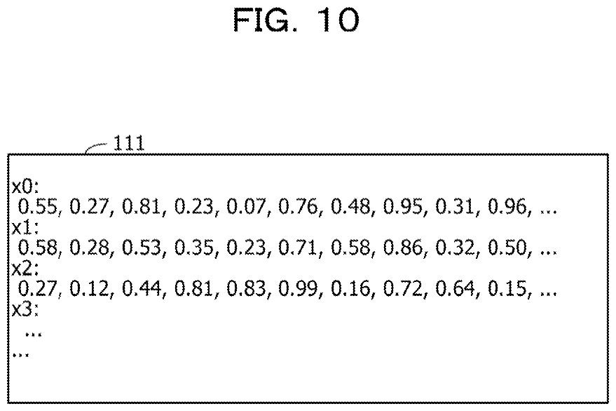

FIG. 10 is a diagram illustrating exemplary sample data. The sample data 111 includes values obtained by multiple observations for each of the plurality of variables. The example of FIG. 10 indicates a numerical array for each variable. Numerical values of the same order in the individual variable arrays indicate, for example, observed values of the individual variables obtained under the same observation conditions (sate date and time, same state of the observation target, etc.).

A job execution instruction including the sample data 111 is transmitted from the control node 100 to each of the computation nodes 200, 200a, and so on. Then, the processes for individual cores in the computation nodes 200, 200a, and so on execute the processing in coordination with each other to determine the causal order.

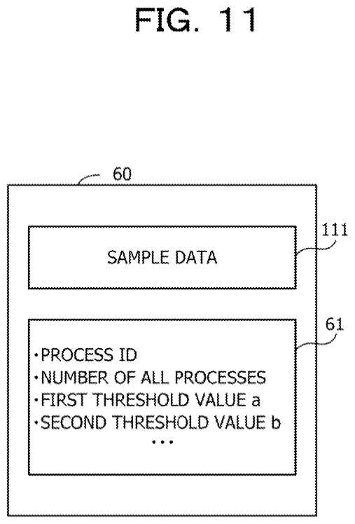

FIG. 11 is a diagram illustrating an exemplary job execution instruction. A job execution instruction 60 transmitted from the control node 100 to each of the computation nodes 200, 200a, and so on includes the sample data 111 and a parameter group 61. The parameter group 61 includes parameters to be used to autonomously determine the content of the processing (non-speculation/speculation, etc.) for determining the causal order of variables. The parameters include the process ID of the destination process, the total number of processes to be used for the causal order determination (equal to the maximum number of parallel executions), the first threshold value a, the second threshold value b, and the like.

Next, a procedure of the causal order determination process executed by each process that has received the job execution instruction will be described.

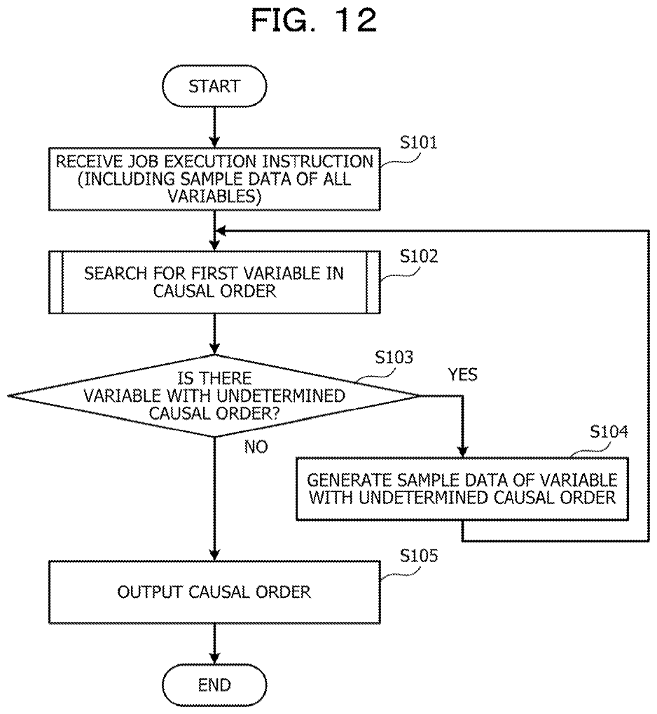

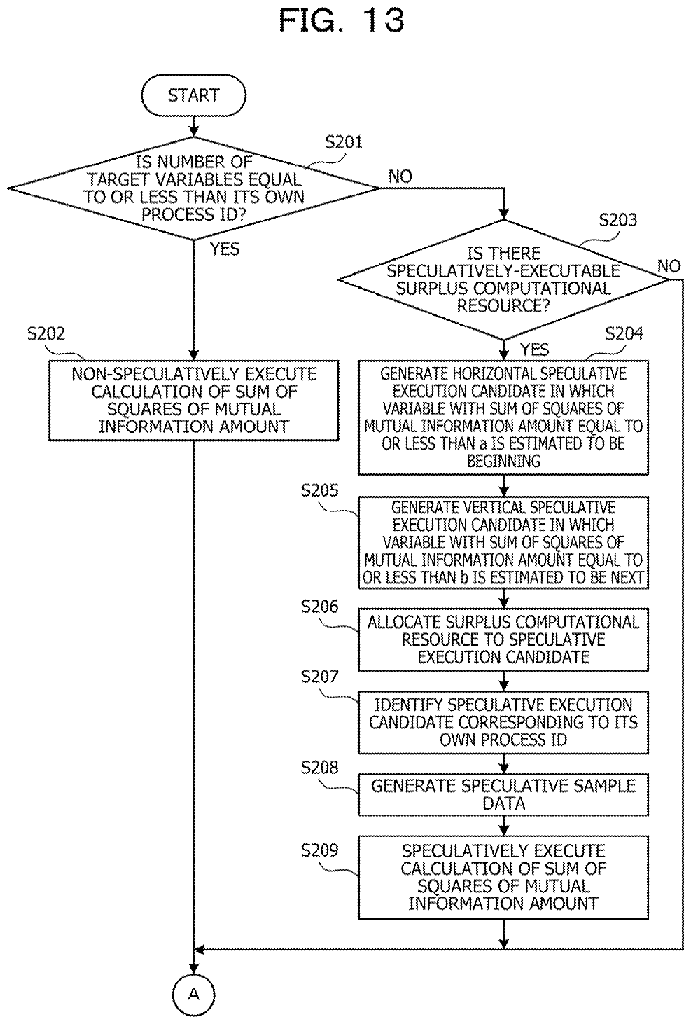

FIG. 12 is a diagram illustrating an exemplary procedure of the causal order determination process. Hereinafter, the process illustrated in FIG. 12 will be described in accordance with step numbers.

[Step S101] The execution processing determination unit 210 receives a job execution instruction from the control node 100. The job execution instruction includes the sample data 111 for all variables.

[Step S102] The execution processing determination unit 210, the mutual information amount calculation unit 220, the inter-process communication unit 230, and the causal order determination unit 240 cooperate to carry out processing of searching for the variable at the beginning of the causal order. Details of this processing will be described later (see FIG. 13).

[Step S103] The causal order determination unit 240 determines whether or not there is a variable whose causal order is undetermined. If there is a variable whose causal order is undetermined, the causal order determination unit 240 advances the process to step S104. Furthermore, if the causal order is determined for all the variables, the causal order determination unit 240 advances the process to step S105.

[Step S104] The execution processing determination unit 210 generates sample data of variables whose causal order is undetermined. For example, the execution processing determination unit 210 generates, on the basis of the sample data used in the previous search process for the variable at the beginning of the causal order, sample data from which the contribution of the variable determined to be the beginning of the causal relationship by the search process is removed. For example, the execution processing determination unit 210 carries out regression analysis of other variables with the variable determined to be the beginning of the causal relationship by the previous search process, and calculates the residual. The residual indicates a distance from the point corresponding to the variable value in the sample data to the regression line obtained by the regression analysis. The newly generated sample data does not include data regarding the variables whose causal order has already been determined.

The generated sample data is used in the next processing of step S102. When the execution processing determination unit 210 generates the sample data of the variable whose causal order is undetermined, it advances the process to step S102.

[Step S105] The causal order determination unit 240 transmits, to the control node 100, the causal order determined for all the variables as a processing result.

The causal order is obtained in this manner. Next, the process of searching for the variable at the beginning of the causal order will be described in detail.

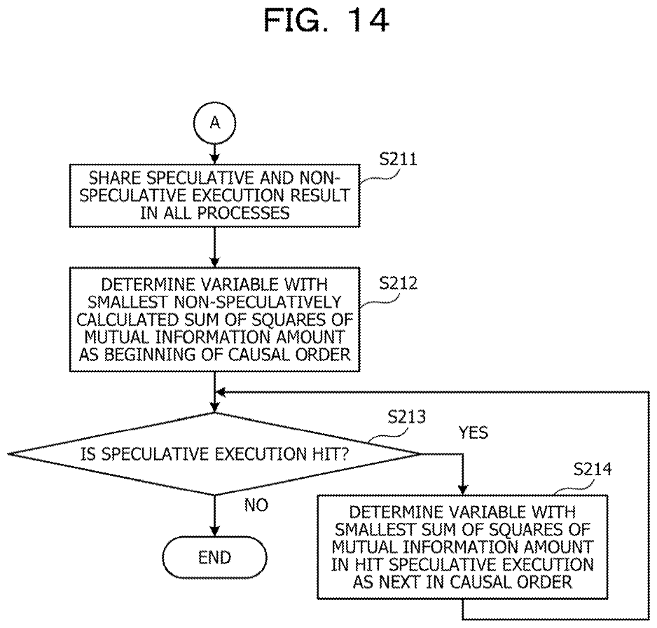

FIG. 13 is the first half of a flowchart illustrating an exemplary procedure of the process of searching for the variable at the beginning of the causal order. Hereinafter, the process illustrated in FIG. 13 will be described in accordance with step numbers.

[Step S201] The execution processing determination unit 210 determines whether or not the number of target variables indicated in the sample data is equal to or less than its own process ID. If the number of target variables is equal to or less than its own process ID, the execution processing determination unit 210 advances the process to step S202. Furthermore, if the number of target variables is larger than its own process ID, the execution processing determination unit 210 advances the process to step S203.

[Step S202] The mutual information amount calculation unit 220 calculates the sum of squares of the mutual information amount of the variable corresponding to its own process ID among the target variables indicated in the sample data on the basis of the sample data. For example, the mutual information amount calculation unit 220 identifies the variable having the same order as its own process ID when the target variables are arranged in ascending order of identification numbers as a variable to be calculated by itself. Then, the mutual information amount calculation unit 220 calculates mutual information amount between the identified variable and each of other target variables, and calculates the sum of squares of the mutual information amount for each of the other target variables. Thereafter, the mutual information amount calculation unit 220 advances the process to step S211 (see FIG. 14).

[Step S203] The execution processing determination unit 210 determines whether or not there are surplus computational resources that may be subject to speculative execution. For example, if there are surplus computational resources of “one less than the number of target variables” (processes not used for non-speculative execution), the execution processing determination unit 210 determines that there are surplus computational resources that may be subject to speculative execution. If there are surplus computational resources that may be subject to speculative execution, the execution processing determination unit 210 advances the process to step S204. Furthermore, if there is no surplus computational resource that may be subject to speculative execution, the execution processing determination unit 210 advances the process to step S211 (see FIG. 14).

[Step S204] The execution processing determination unit 210 estimates a variable in which the sum of squares of the mutual information amount is equal to or less than the first threshold value a as the beginning of the variables whose causal order is undetermined on the basis of the inter-process shared information obtained by the previous data sharing in all the processes. Then, the execution processing determination unit 210 generates a process of searching for the beginning of the variables whose causal order is undetermined other than the variable whose causal order is estimated as a horizontal speculative execution candidate.

[Step S205] The execution processing determination unit 210 estimates a variable in which the sum of squares of the mutual information amount is larger than the first threshold value a and equal to or less than the second threshold value b to be the next to the variable estimated to be the beginning in the causal order in step S204 on the basis of the inter-process shared information obtained by the previous data sharing in all the processes. Then, the execution processing determination unit 210 generates a process of searching for the beginning of the variables whose causal order is undetermined other than the variable whose causal order is estimated as a vertical speculative execution candidate.

[Step S206] The execution processing determination unit 210 allocates the surplus computational resources to the horizontal speculative execution candidates or the vertical speculative execution candidates. For example, the execution processing determination unit 210 first allocates the surplus computational resources to the horizontal speculative execution candidates. At this time, the execution processing determination unit 210 allocates the surplus computational resources earlier as the horizontal speculative execution candidate has a smaller sum of squares of the mutual information amount of the estimated variable. If there are unallocated surplus computational resources after the allocation to all the horizontal speculative execution candidates is complete, the execution processing determination unit 210 allocates the surplus computational resources to the vertical speculative execution candidates. At this time, the execution processing determination unit 210 allocates the surplus computational resources earlier as the vertical speculative execution candidate has a smaller sum of squares of the mutual information amount of the estimated variable.

[Step S207] The execution processing determination unit 210 identifies the speculative execution candidate (horizontal speculative execution candidate or vertical speculative execution candidate) to which its own process is assigned on the basis of its own process ID. Note that, if its own process is not assigned to any speculative execution candidate, the execution processing determination unit 210 skips the following process of steps S208 to S209, and advances the process to step S211. If it has succeeded to identify the assigned speculative execution candidate, the execution processing determination unit 210 advances the process to step S208.

[Step S208] The execution processing determination unit 210 generates speculative sample data. For example, the execution processing determination unit 210 generates sample data obtained by removing the contribution of the variables whose causal order is determined and the variables whose causal order is estimated.

[Step S209] The mutual information amount calculation unit 220 calculates the sum of squares of the mutual information amount of the variable corresponding to its own process ID among the target variables indicated in the speculative sample data on the basis of the speculative sample data. For example, the mutual information amount calculation unit 220 identifies the order of its own process when the individual processes assigned to the speculative execution candidates to be executed are arranged in ascending order of process ID. Then, the mutual information amount calculation unit 220 identifies the variable having the same order as the order of its own process when the target variables are arranged in ascending order of identification numbers as a variable to be calculated by itself. Then, the mutual information amount calculation unit 220 calculates mutual information amount between the identified variable and each of other target variables, and calculates the sum of squares of the mutual information amount for each of the other target variables. Thereafter, the mutual information amount calculation unit 220 advances the process to step S211 (see FIG. 14).

FIG. 14 is the latter half of the flowchart illustrating the exemplary procedure of the process of searching for the variable at the beginning of the causal order. Hereinafter, the process illustrated in FIG. 14 will be described in accordance with step numbers.

[Step S211] The inter-process communication unit 230 obtains the calculation result of the sum of squares of the mutual information amount calculated by the mutual information amount calculation unit 220. Next, the inter-process communication unit 230 performs inter-process communication with another process assigned to the same job, transmits the calculation result of the sum of squares of the mutual information amount calculated by its own process 201a, and obtains the calculation result of the another process. As a result, the inter-process shared information indicating the speculative and non-speculative execution result is shared in the processes assigned to the same job.

[Step S212] The causal order determination unit 240 obtains the inter-process shared information from the inter-process communication unit 230, and determines the variable with the smallest sum of squares of the mutual information amount non-speculatively calculated as the beginning of the variables whose causal order is undetermined.

[Step S213] The causal order determination unit 240 determines whether any of the speculative executions of the sum of squares of the mutual information amount is hit. For example, the causal order determination unit 240 determines that the speculative execution is hit when the calculation result of the speculative execution that estimates the causal order of the variable whose causal order is determined last is obtained. If the speculative execution is hit, the causal order determination unit 240 advances the process to step S214. Furthermore, if the speculative execution is not hit, the causal order determination unit 240 terminates the process of searching for the variable at the beginning of the causal order.

[Step S214] The causal order determination unit 240 determines the variable with the smallest sum of squares of the mutual information amount in the hit speculative execution as the variable in the next causal order. Thereafter, the causal order determination unit 240 advances the process to step S213.

In this manner, each process is enabled to autonomously determine the next speculative execution content on the basis of the result of the previously executed non-speculative execution, and the communication time for the speculative execution is not needed. Moreover, the speculative execution content is determined on the basis of the sum of squares of the mutual information amount for each variable indicated in the previously executed non-speculative execution, whereby the hit rate improves and the overall processing is made more efficient.

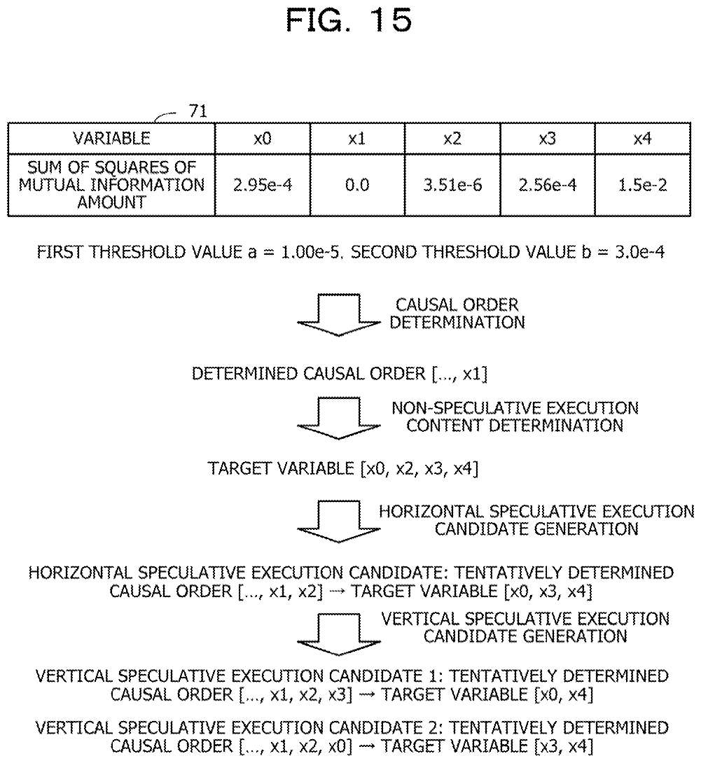

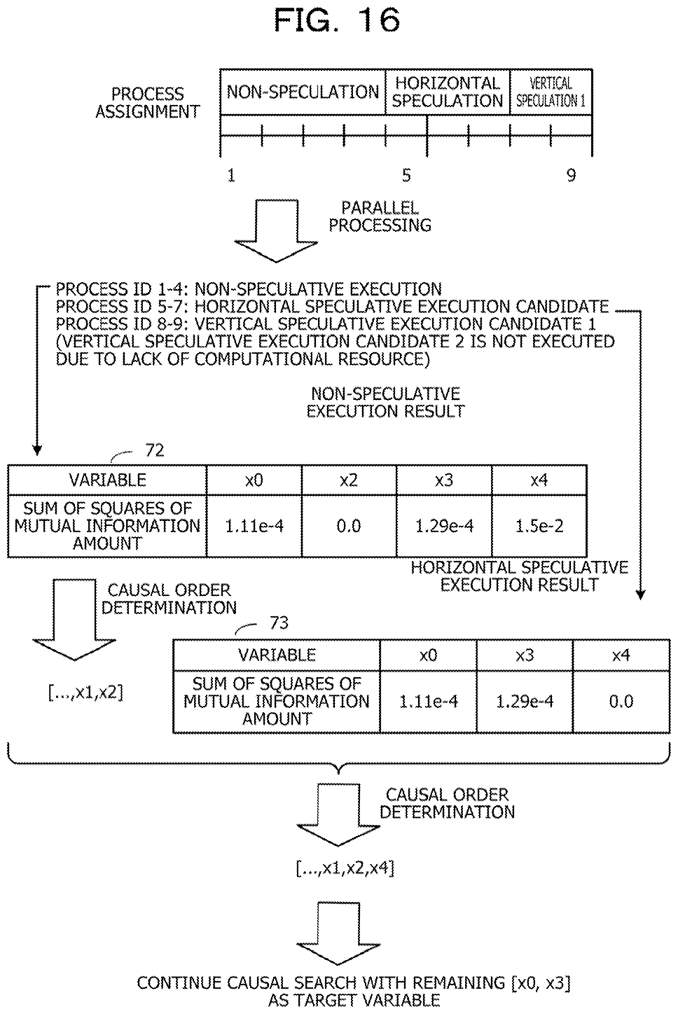

Hereinafter, a specific example of the causal order determination process will be described with reference to FIGS. 15 and 16.

FIG. 15 is a first diagram illustrating exemplary causal order determination. In the example of FIG. 15, it is assumed that the maximum number of parallel executions (number of processes) is “9”. Furthermore, the first threshold value regarding the horizontal speculative execution is a=1.00e−5, and the second threshold value regarding the vertical speculative execution is b=3.0e−4 (e−k represents 10^{-k}).

It is assumed that the sum of squares of the mutual information amount in the previous search process is shared by inter-process communication and inter-process shared information 71 as illustrated in FIG. 15 is obtained. In the inter-process shared information 71, the sum of squares of the mutual information amount regarding the variable “x1” is the smallest. Therefore, the variable “x1” is determined to be the beginning of the causal order among the variables “x0, x1, x2, x3, and x4”. In a case where there is a causal order that has already been determined, “x1” is added to the end of the causal order (causal order [ . . . , and x1]).

Since the causal order of the variable “x1” is determined, “x0, x2, x3, and x4” other than the variable “x1” are to be the target variables in the non-speculative execution in the next step. In the horizontal speculation, one of “x0, x2, x3, and x4” is estimated to be the variable next to “x1” in the causal order. The variable to be estimated as the next order is a variable in which the calculated sum of squares of the mutual information amount is equal to or less than the first threshold value a. In the example of FIG. 15, the sum of squares of the mutual information amount of the variable “x2” is “3.51e−6”, which is equal to or less than the first threshold value a (=1.00e−5). Accordingly, the variable “x2” among “x0, x2, x3, and x4” is estimated to be the beginning of the causal order, and horizontal speculative execution candidates are generated. In this horizontal speculative execution candidate, the sum of squares of the mutual information amount of each of “x0, x3, and x4” are calculated assuming that the causal order is [ . . . , x1, and x2].

In the example of FIG. 15, only the variable “x2” has the sum of squares of the mutual information amount equal to or less than the first threshold value a, and thus only one horizontal speculative execution candidate is generated. Next, vertical speculative execution candidates are generated.

As the vertical speculative execution candidate, a variable in which the calculated sum of squares of the mutual information amount is equal to or less than the second threshold value b is estimated as a variable following the causal order [ . . . , x1, and x2] assumed at the time of generating the horizontal speculative execution candidate. In the example of FIG. 15, the sum of squares of the mutual information amount of the variable “x0” is “2.95e−4” and the sum of squares of the mutual information amount of the variable “x3” is “2.56e−4”, both of which are equal to or less than the second threshold value b (=3.0e−4). Comparing the sum of squares of the mutual information amount between the variable “x0” and the variable “x3”, the variable “x3” has a smaller value.

Accordingly, the variable “x3” among “x0, x3, and x4” is estimated to be the beginning of the causal order, and the first vertical speculative execution candidate (vertical speculative execution candidate 1) is generated. In this vertical speculative execution candidate, the sum of squares of the mutual information amount of each of “x0 and x4” are calculated assuming that the causal order is [ . . . , x1, x2, and x3].

Next, the variable “x0” among “x0, x3, and x4” is estimated to be the beginning of the causal order, and the second vertical speculative execution candidate (vertical speculative execution candidate 2) is generated. In this vertical speculative execution candidate, the sum of squares of the mutual information amount of each of “x3 and x4” are calculated assuming that the causal order is [ . . . , x1, x2, and x0].

FIG. 16 is a second diagram illustrating exemplary causal order determination. When the contents of the non-speculative execution and speculative execution candidates are determined, processes are assigned to each of them. For example, four processes with the process IDs “1” to “4” are assigned to the non-speculative execution. Three processes with the process IDs “5” to “7” are assigned to the horizontal speculative execution candidate. Two processes with the process IDs “8” and “9” are assigned to the first “vertical speculative execution candidate 1”. No process is assigned to the second “vertical speculative execution candidate 2” due to lack of computational resources.

Each of processes to which processing is assigned calculates the sum of squares of the mutual information amount of one of the target variables according to the assigned processing. For example, the individual processes with the process IDs “1” to “4” assigned to the non-speculative execution calculates the sum of squares of the mutual information amount of the variables “x0, x2, x3, and x4”, respectively. Furthermore, the individual processes with the process IDs “5” to “7” assigned to the horizontal speculative execution candidate calculates the sum of squares of the mutual information amount of the variables “x0, x3, and x4”, respectively. Moreover, the individual processes with the process IDs “8” and “9” assigned to the “vertical speculative execution candidate 1” calculates the sum of squares of the mutual information amount of the variables “x0 and x4”, respectively. The “vertical speculative execution candidate 2” is not executed as there are no computational resources.

When the parallel calculation by the individual processes is complete, the calculation results are shared by inter-process communication, and pieces of inter-process shared information 72 and 73 are generated in each process. The inter-process shared information 72 indicates the result of the non-speculative execution, and the inter-process shared information 73 indicates the result of the horizontal speculative execution candidate. Although illustration is omitted, inter-process shared information indicating the execution result of the “vertical speculative execution candidate 1” is also generated.

In the inter-process shared information 72 indicating the result of the non-speculative execution, the sum of squares of the mutual information amount of the variable “x2” is the smallest. Accordingly, “x2” is determined to be the beginning of the causal order among the variables “x0, x2, x3, and x4”. For example, the next variable in the causal order that has already been determined is “x2” (causal order [ . . . , x1, and x2).

In the example of FIG. 16, the causal order search when the contribution of the variable “x2” is removed has already been calculated by the horizontal speculative execution. For example, it is determined that the horizontal speculative execution is hit. In the inter-process shared information 73 indicating the result of the horizontal speculative execution, the sum of squares of the mutual information amount of the variable “x4” is the smallest. Accordingly, “x4” is determined to be the beginning of the causal order among the variables “x0, x3, and x4”. For example, the next variable in the causal order that has already been determined is “x4” (causal order [ . . . , x1, x2, and x4).

Here, the causal order search when the contribution of the variables “x2 and x4” are removed has not been carried out. For example, the vertical speculative execution is not hit. Accordingly, in the next causal order search, the causal order search with the remaining variables “x0 and x3” as the target variables is carried out as non-speculative execution.

As illustrated in FIGS. 15 and 16, each process is enabled to autonomously determine the content to be calculated by itself in the next causal order search including the speculative execution by only using the calculation result of the previous causal order search. As a result, the overhead due to excess negotiation for the speculative execution is suppressed, and efficient processing is performed.

Furthermore, with the two threshold values set to properly use the horizontal speculative execution and the vertical speculative execution, the hit rate of the speculative execution improves, and the processing time until the causal order of all the variables is determined is shortened.

### Other Embodiments

While the example of the causal order search according to DirectLiNGAM has been described in the second embodiment, the same processing may be applied to other methods in which the causal order is estimated using a statistical information amount and is determined in stages.

The embodiments have been exemplified above, and the configuration of each unit described in the embodiments may be replaced with another configuration having a similar function. Furthermore, any other components and steps may be added. Moreover, any two or more configurations (features) of the embodiments described above may be combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a causal search program for causing a computer to execute a process comprising:
executing, on the basis of first sample data that includes a numerical string of each of a plurality of variables to be calculated, parallel processing of calculation of a first statistical information amount between each of the plurality of variables and another variable through a plurality of processes;
sharing the first statistical information amount of each of the plurality of variables between the plurality of processes;
determining a first variable to be a beginning of a causal order in which the plurality of variables is arranged in such a manner that a variable that may be a cause in a causal relationship between the plurality of variables precedes on the basis of the first statistical information amount of each of the plurality of variables through each of the plurality of processes;
estimating a second variable to be next to the first variable in the causal order among the plurality of variables on the basis of the first statistical information amount of each of the plurality of variables through each of the plurality of processes; and
determining, through each of the plurality of processes, calculation execution of a second statistical information amount between each of remaining variables in which the first variable is excluded from the plurality of variables and other remaining variables based on second sample data obtained by removing a contribution of the first variable from the first sample data and calculation execution of a third statistical information amount between each of remaining variables in which the first variable and the second variable are excluded from the plurality of variables and the other remaining variables based on third sample data obtained by removing the contribution of the first variable and the second variable from the first sample data.

2. The non-transitory computer-readable recording medium according to claim 1, wherein
the estimating the second variable estimates a variable in which the first statistical information amount is equal to or less than a first threshold value as the second variable.

3. The non-transitory computer-readable recording medium according to claim 1, wherein
in a case where there is a plurality of the second variables, the determining the calculation execution of the third statistical information amount determines the calculation execution of the third statistical information amount for each of the plurality of second variables within a range allowed by an available computational resource.

4. The non-transitory computer-readable recording medium according to claim 1, the medium storing the causal search program for causing the computer to execute the process further comprising:
estimating a third variable to be next to the second variable in the causal order among the plurality of variables on the basis of the first statistical information amount of each of the plurality of variables through each of the plurality of processes; and
determining, through each of the plurality of processes, calculation execution of a fourth statistical information amount between each of remaining variables in which the first variable, the second variable, and the third variable are excluded from the plurality of variables and the other remaining variables based on fourth sample data obtained by removing the contribution of the first variable, the second variable, and the third variable from the first sample data.

5. The non-transitory computer-readable recording medium according to claim 4, wherein
the estimating the third variable estimates a variable, which is other than the first variable, in which the first statistical information amount is equal to or less than a second threshold value as the third variable.

6. The non-transitory computer-readable recording medium according to claim 1, the medium storing the causal search program for causing the computer to execute the process further comprising:
determining, through each of the plurality of processes, the second statistical information amount or the third statistical information amount of which variable is to be calculated on the basis of process ID of each of the processes, and calculating the second statistical information amount or the third statistical information amount of the determined variable.

7. A causal search method comprising:
executing, on the basis of first sample data that includes a numerical string of each of a plurality of variables to be calculated, parallel processing of calculation of a first statistical information amount between each of the plurality of variables and another variable through a plurality of processes;
sharing the first statistical information amount of each of the plurality of variables between the plurality of processes;
determining a first variable to be a beginning of a causal order in which the plurality of variables is arranged in such a manner that a variable that may be a cause in a causal relationship between the plurality of variables precedes on the basis of the first statistical information amount of each of the plurality of variables through each of the plurality of processes;
estimating a second variable to be next to the first variable in the causal order among the plurality of variables on the basis of the first statistical information amount of each of the plurality of variables through each of the plurality of processes; and
determining, through each of the plurality of processes, calculation execution of a second statistical information amount between each of remaining variables in which the first variable is excluded from the plurality of variables and other remaining variables based on second sample data obtained by removing a contribution of the first variable from the first sample data and calculation execution of a third statistical information amount between each of remaining variables in which the first variable and the second variable are excluded from the plurality of variables and the other remaining variables based on third sample data obtained by removing the contribution of the first variable and the second variable from the first sample data.

8. An information processing apparatus comprising:
a memory; and
a processor coupled to the memory and configured to:
execute, on the basis of first sample data that includes a numerical string of each of a plurality of variables to be calculated, parallel processing of calculation of a first statistical information amount between each of the plurality of variables and another variable through a plurality of processes;
share the first statistical information amount of each of the plurality of variables between the plurality of processes;
determine a first variable to be a beginning of a causal order in which the plurality of variables is arranged in such a manner that a variable that may be a cause in a causal relationship between the plurality of variables precedes on the basis of the first statistical information amount of each of the plurality of variables through each of the plurality of processes;
estimate a second variable to be next to the first variable in the causal order among the plurality of variables on the basis of the first statistical information amount of each of the plurality of variables through each of the plurality of processes; and
determine, through each of the plurality of processes, calculation execution of a second statistical information amount between each of remaining variables in which the first variable is excluded from the plurality of variables and other remaining variables based on second sample data obtained by removing a contribution of the first variable from the first sample data and calculation execution of a third statistical information amount between each of remaining variables in which the first variable and the second variable are excluded from the plurality of variables and the other remaining variables based on third sample data obtained by removing the contribution of the first variable and the second variable from the first sample data.
